(19) United States
(12) Patent Application Publication
(10) Pub. No.: US 2026/0340667 A1
(43) Pub. Date: Oct. 29, 2026

(54) Vanity Search Method and Apparatus

(71) Applicant: Luis A. Martinez El'Gazi, Laguna Beach, CA (US)

(72) Inventor: Luis A. Martinez El'Gazi, Laguna Beach, CA (US)

(21) Appl. No.: 19/565,922

(22) Filed: Mar. 13, 2026

Related U.S. Application Data
(60) Provisional application No. 63/771,514, filed on Mar. 13, 2025.

(51) Int. Cl. G06Q 30/0202; G06F 40/58

(52) U.S. Cl. CPC G06Q 30/0202; G06F 40/58

(57) ABSTRACT

An apparatus, system or method of assigning a telephone number to an end user wherein the number is assigned by creating a database of number combinations of available telephone numbers, both with and without area codes, followed by correlating the database of number combinations to words in a desired language, wherein the end user provides input of one or more letter combinations that are of interest to the end user, and a computer-readable algorithm compares the database of numbers to the letter combinations that are of interest to identify any correlations or matches, whereas each correlation or match has a value, further assigned by a computer-readable algorithm, and the correlating/matched numbers are displayed to the end user.

### PRIORITY STATEMENT

This Application claims the benefit of U.S. Provisional Patent Application No. 63/771,514, filed Mar. 13, 2025, the entirety of which is incorporated herein by reference.

### TECHNICAL FIELD

The present disclosure relates to a system which enables an end user to identify customized, vanity phone numbers by entering interests, various terms, and alphabetical characters into the keypad. Software incorporates artificial intelligence (“AI Software”) to identify related and relevant terms and translates alphabetical characters into corresponding numerical characters. AI software is able to suggest different results based on different levels of accuracy and personalized preferences to accommodate users desire for individuality. AI software may also suggests alternatives if no exact or directly related matches are available. AI software is agnostic and can apply to any phone number database from any country. AI software may further incorporate a pricing algorithm that categorizing numbers based on manual entry, number patterns, number relationships between last four, NPA and NPX, are codes, numbers of words it can spell, number of letters it uses, and provides highest value option. Relational databases are used to determine relevance, importance and commonality. Databases include for example sports related, business related, famous people, arts, music, affinity groups, social interests etc. AI software may also allows system to incorporate demand hierarchy component for additional price correction and/or sensitivity.

### BACKGROUND ART

As part of a marketing strategy, businesses, individuals and organizations frequently utilize so-called “vanity numbers” as telephone numbers. Ordinarily, telephone numbers are presented as a series of numeric digits which are to be entered into the keypad of a telephone. Vanity numbers present recognizable text in place of some or all of the digits. The text which has been selected imparts identity and recognition in the eye of the public. The text may comprise the name of the business, individual, nickname, relation, or organization, or may comprise a term indicative of the nature or identity of the individual, business or organization. Illustratively, a florist may adopt 1-800-FLOWERS as a phone number.

Examples of vanity numbers may include 213-333-ADAM, 909 9DI SNEY, 213-333-FROG, 213 333-SELL, 714 SWI-FTIE, 415 COO-LGUY to name a few. Historically, the value of phone numbers (toll free and local) has been primarily business focused. It's about numbers that are easy to remember for consumers that can be advertised on tv, radio, and the web. Those numbers will either be “repeaters”-numbers that somehow repeat and easy to remember. for example 213-333-4444, 213-333-3000, or nostalgic for age group like 213 333-1969. Or it may consist of numbers that spell something significant to a service provider, individual or merchant like 949 DEN TIST and 714 FLO RIST.

Historically these numbers have been sold through either some basic websites that illustrates some translated numbers or, at most show the NPA (NPA=area code) to enter and the NXX (NXX-next three) to enter, followed by the spelling of various recognizable words and/or names with the remaining four numbers/letters. However, if you were looking to find something yourself, the industry relied on salespeople and intermediaries to search those numbers. Vanity number sellers have pricing logic and algorithms to put a value on the numbers they offer for sale, with this logic ranging from very simple to more comprehensive rule sets. The most common valuation is related to area code plus if it was a repeater of a certain value or a knowledge base of words that they knew to be in demand, like for example: “THELAW”.

However, the existing business metrology includes several limitations which have hindered the both the sales and value of vanity numbers. For instance; (1) Out of 100 numbers, only 5-10% have some real value to that world as they spell something valuable or are true repeaters. The other 90% have little discernible characteristics that justify a higher price. In addition, (2) The market is controlled and dominated by middlemen and entities that control the largest set of numbers. A few large players have accumulated substantial inventory over the years and therefore control pricing for the area codes and numbers they own. And those numbers cannot be replicated except for when new zip codes are issued. Furthermore, (3) The market is business oriented and relatively cost prohibitive for personal users, and the market is priced very highly as it focuses on selling or leasing high value numbers. The value of certain numbers is extremely high to businesses, so they are willing to pay large amounts to secure them. Finally, (6) searching for numbers is difficult as it centers on searching for a specific number or spelling. End users need to know what they want and sellers attempt to place a value on that number. (In the example above, anyone searching for 800 927-3586 would find a relatively low cost number unless the seller was aware that it spells Xarelto and factored that into listed price.) From an individual user's perspective, none of the competitive search tools are geared to helping users find similar or similarly themed adjacent alternatives.

Searches are often confined to the search terms, and controlled by the seller and limited to what a person can search themselves versus helping users find quality numbers they might not know exist.

Existing variant of these vanity number searching platforms include: Examples of existing websites to find numbers are as follows: https://www.numberbarn.com/vanity-phone-numbers; https://www.800.com/; https://phonenumberguy.com/store/california/; https://www.numbergarage.com/features/new-phone-numbers; https://www.easyringer.com/features/vanity-phone-numbers

As can be appreciated, these rudimentary search methods fail to produce adequate results to the end user, and fail to go beyond the simple search terms provided by the end user. The subject innovation aims to transcend this model by applying smart search capabilities for vanity numbers, allowing for a greater variety of possible vanity numbers and appreciated sales accordingly.

### SUMMARY OF THE DISCLOSURE

The subject disclosure teaches an apparatus, system or method of assigning a telephone number to an end user wherein the method has the steps of creating a database of number combinations of available telephone numbers, both with and without area codes, followed by correlating the database of number combinations to words in a desired language, wherein the end user provides input of one or more letter combinations that are of interest to the end user, and an algorithm housed in a computer compares the database of numbers to the letter combinations that are of interest to identify any correlations or matches, whereas each correlation or match has a value, further assigned by a computer-readable algorithm, and the correlating/matched numbers are displayed to the end user.

In various embodiments of the method, the database of number combinations may include one or more third-party databases.

In other embodiment, the one or more letter combinations include a preceding and/or following number from zero to nine, prior to searching and identifying any correlations.

In other contemplated embodiment, the method further comprising comparing the database of numbers to the letter combinations that are of interest to identify any correlations, in a specific area code. Furthermore, the database comprises more than one area code, and more than one area code may be selected when identifying a correlation/match.

The method further comprises, if the identification of correlations is not successful, a letter in the one or more letter combinations is correlated by using at least one phonetic equivalent letter and if a phonetic equivalent correlation is found, displaying said phonetic equivalent correlation to the end user.

The method may further comprise the steps of: translating the one or more letter combinations into a different language and correlating the database with the translated letter combination.

In various embodiment, the AI software is able to suggest different results based on different levels of accuracy and personalized preferences to accommodate users desire for individuality. AI software may also suggests alternatives if no exact or directly related matches are available. AI software is agnostic and can apply to any phone number database from any country. AI software may further incorporate a pricing algorithm that categorizing numbers based on manual entry, number patterns, number relationships between last four, NPA and NPX, are codes, numbers of words it can spell, number of letters it uses, and provides highest value option. Relational databases are used to determine relevance, importance and commonality. Databases include for example sports related, business related, famous people, arts, music, affinity groups, social interests etc. AI software may also allows system to incorporate demand hierarchy component for additional price correction and/or sensitivity.

### BRIEF DESCRIPTION OF DRAWINGS

The accompanying drawings, which are incorporated in and constitute a part of the specification, illustrate exemplary embodiments of the present innovation.

FIG. 1 is a block diagram depicting various elements, in accordance to one or more embodiment of the subject disclosure.

FIG. 2 is an image of an exemplary search engine, in according to one or more embodiment of the subject disclosure.

FIG. 3 provides an image of an exemplary search engine, in according to one or more embodiment of the subject disclosure.

FIG. 4 provides an image of an exemplary search engine, in according to one or more embodiment of the subject disclosure, specifically here the ‘zupersearch’ engine.

FIG. 5 illustrates an image of an exemplary search engine based on geography, in according to one or more embodiment of the subject disclosure.

Throughout the Figures, the same reference numerals and characters, unless otherwise stated, are used to denote like features, elements, components or portions of the illustrated embodiments. In addition, reference numeral(s) including by the designation “′” (e.g. 12′ or 24′) signify secondary elements and/or references of the same nature and/or kind. Moreover, while the subject disclosure will now be described in detail with reference to the Figures, it is done so in connection with the illustrative embodiments. It is intended that changes and modifications can be made to the described embodiments without departing from the true scope and spirit of the subject disclosure as defined by the appended paragraphs.

### DETAILED DESCRIPTION

The following description of exemplary embodiment(s) is merely illustrative in nature and is in no way intended to limit the innovation, its application, or uses.

The subject innovation commences by addressing some certainties within the industry. Namely, (1) that of huge number of local phone number, only a small percentage have some significant value which we are stating to be above $200 (US). (2) Individuals would find value in these non-significant value numbers as they might mean something to the individual(s) on a personal level. There is a vast number of potential individuals who are not business buyers, but who would like to get a number that is easy to remember and means something to them at a reasonable price. People are different and have different ways of searching for relevant numbers. They don't always know what they want and need assistance finding what's best for them.

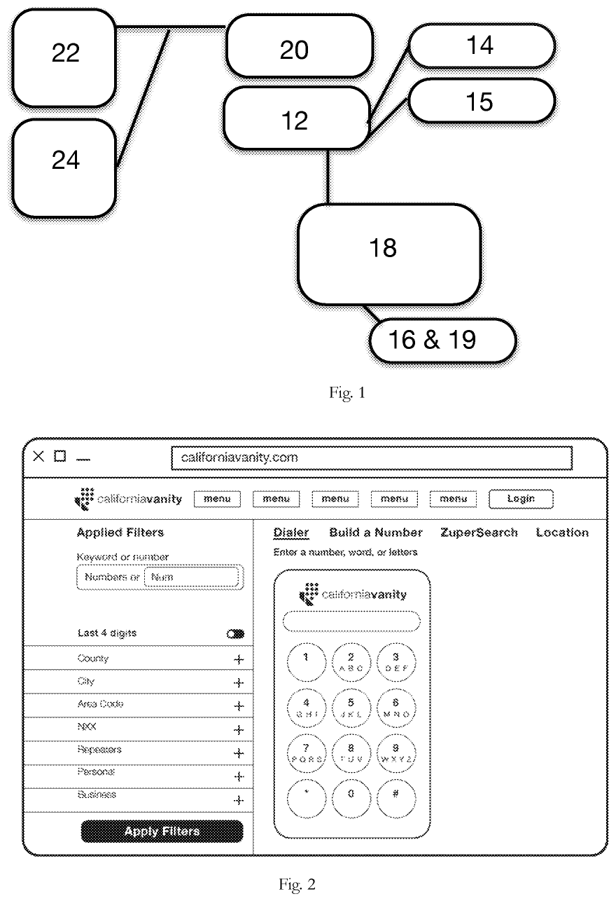

Utilizing the subject innovation may require an electronics based work station 10, as seen in FIG. 1. The work station 10 may include a processor 12 which processes information and outputs information in various forms. The processor 12 is connected to a memory 14 for storing long-term and short term information. The memory 14 may also include ROM and RAM or their equivalents, as is known in electronic workstations. In addition the processor 12 is also in electronic communication with a local storage device 15, which may be a chip or similar device for long term storage of information such as programs, data files, records, and databases. The processor 12 is also in electronic communication to a user input device 16 and output device 18. The input device 16 may include a keyboard, mouse, or other relay devices for imputing information to the work station 10 by an end user 100. The output device 18 may be a monitor for displaying information or a speaker which allows the user to hear auditory prompts and recitals that workstation may output. The processor 12 is also in electronic communication with the input device 16 and the display 18 in order to enable input from the end user 100 and visual output to the end user 100.

The processor 12, memory 14, local storage device 15, speaker 16, display 18 and keyboard 19 enable the workstation 10 to perform many reading, comparing, querying and writing tasks on integers, characters and databases for evaluating possible number/letter configurations which may be of interest to the end suer 100. The electronic workstation 10 provides abilities as a stand alone unit; however, an internet connection 20 allows the workstation 10 to connect to the world wide web. This connection to the world wide web includes a telecommunications signaling network world and telecommunications network databases, such as local routing number (LRN) database 22. The LRN database is a grouping of unused numbers may be used for assigning a telephone number to an end user 100.

The internet connection 20 further connects the workstation 10 to other databases, including a unused number database 24. This unused number database 24 is populated with unused numbers from various other sources or databases, such as the LRN 22, and may contain numbers from other than the local routing switch area. The unused numbers in databases 22 and 24 may be already grouped into groups of numbers that have some intrinsic value and groups of numbers that have been found not to have intrinsic value beyond being able to complete a call. The workstation 10 is able to relay these numbers to the end user 100, to assist in finding a number relevant to the end suer 100, via filtering actions according to names, synonyms, alternative spellings, etc., or other differentiating elements.

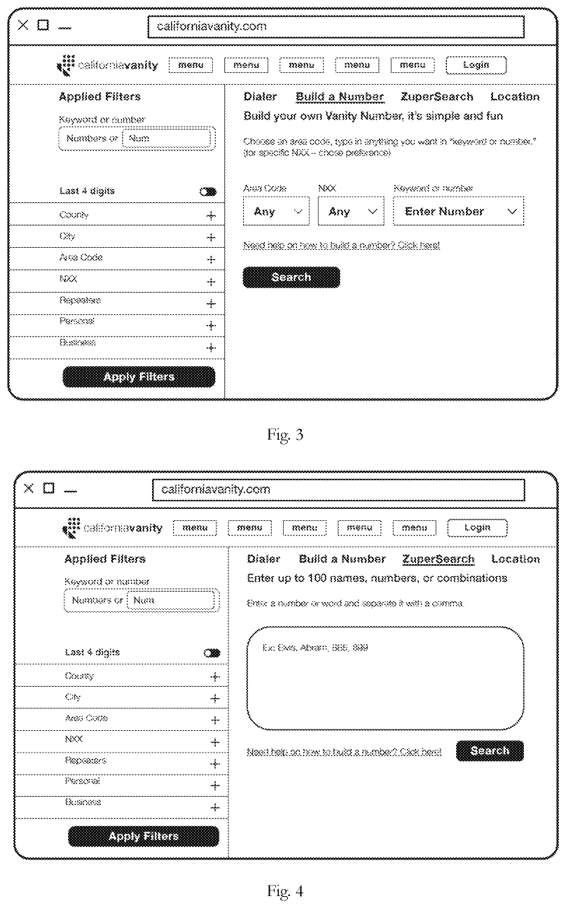

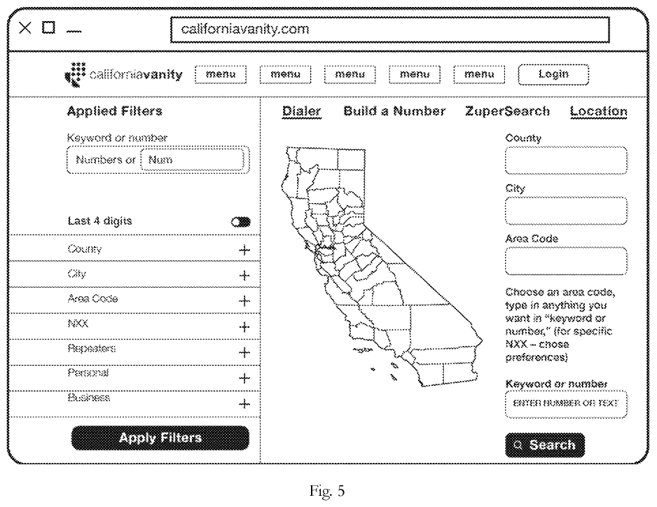

In various embodiments, proprietary machine learning IP 102, utilizing one or more computer-readable algorithms, may be incorporated with the workstation 10, may be utilized to help facilitate curating and finding number/letter variations specific to inputs dependent on the end suers 100 specific needs/wants/relevance. The IP 102 may be a driving method of the subject innovation and the differentiating byproduct search methods/product in the subject innovation. As we see in FIGS. 2-5 of this subject innovation, the workstation 10, as a whole, provides a simple method by which to use this innovation, which allows end users 100 to directly search for number/letter connotations they are looking for. The subject innovation also adds the typical npa+NXX plus whatever as a tool to the workstation 10, perhaps through the internet connection 20. Wherein the typical npa+NXX introduces the ability to search not only the last four digits but all 7 digit variants relevant to the end user 100. The subject innovation also allows end users 100 to enter full sentences and terms to utilize learning IP 102 to search technology that finds relevant and adjacent terms and the corresponding numbers. By way of example, an end user 100 can enter the prompt using the workstation 10: Give me a cool number for Dana Point, California. and the workstation output 18 may compute using the algorithm, and provide the results include 213 333-COOL, 209 222-SURF, and 562 22-CHILL.

The subject innovation also discloses the ZuperSearch which is the ability to simultaneous look for up to 100 words or numbers you may be interested in and obtain the results from such search. Again, everything is geared towards facilitating the search for an end user 100 by allowing them to simultaneously enter up to 100 search words or numbers rather than to do so one by one.

For some users this may be the preferred method of searching as it provides a quicker and user friendly way to obtain hundreds if not thousands of search results practically instantaneously. The entries can be copied and pasted or manually entered and follow the “word, word1,34433,” meaning a word or number followed by a coma. The system also allows the end user to download the results so that they can review in their own time without the need of any third party or salesperson involved.

The subject innovation may also be utilized to create the ability to visually search by using a map as the starting point, narrowing down relevant area codes based on geography—an important characteristic for local businesses and individuals wanting a local tie-in.

So now end users 100 can easily search for any number that they want or any number they might want. The subject innovation then adds additional search capabilities like an Airbnb in that there is an advanced filter that allows you to narrow down your search by any number of qualities. This includes, county, city, zip code, lifestyles, sports, names, business and personal, industries etc. Again, nobody else in the industry provides this level of functionality directly to consumers From an IP perspective, there is uniqueness in the functionality, approach, interaction, and abilities for: Direct to end users Search abilities—a la google.

Some embodiments of the subject innovation can advantageously implement one or more artificial intelligence (AI) or machine learning (ML) algorithms, processes, techniques, or the like (“machine learning IP”) 102, to monitor a sensor of the system and/or apparatus. Such machine learning IP 102 use a neural network, a random forest algorithm, a cognitive computing system, a rules-based engine, or the like, and are trained based on a set of data to assess types of data and generate output. For example, a training algorithm can be configured to facilitate monitoring a sensor of the system and/or apparatus to obtain a sensor reading, performing impact detection based on the sensor reading, generating an impact profile based on the impact detection, characterizing the impact detection, and responding to the impact detection. The model(s) can be configured as software that takes images as input and returns predictions for the given images as output. The model(s) can be an instance of a model architecture (set of parameter values) that has been obtained by model training and selection using a machine learning and/or optimization algorithm/process. A model can generally include, for example, an architecture defined by a source code (e.g. a convolutional neural network including layers of parameterized convolutional kernels and activation functions, or the like) and configuration values (parameters, weights, features, or the like) that are initially set to random values and are then over the course of the training iteratively optimized given data example, an objective function (loss function), an optimization algorithm (optimizer), or the like.

By way of example, the subject algorithms may take user input and find associative terms and some correlative numbers, using machine learning IP 102. For example, the prompts or search terms “I like Disney princesses”, may result in not only identifying Disney related numbers, as well as the results: 909-9DISNEY, 213 36MULAN, 415 JASMINE, and 661 7PIXIES, which are derivatives of Disney princesses, and may even produce princess names outside of Disney.

At least some of the sensor monitoring of the system and/or apparatus to obtain a sensor reading, impact detection based on the sensor reading, generating an impact profile based on the impact detection, characterization of the impact detection, and response to the impact detection can be used as input data and provided to the training algorithm. Sensor readings can be stored in a database to facilitate impact profile and impact detection that are generated using input mapping to the model(s) or through expert research, and machine learning can find parameters for AI processes.

Impact profile and impact detection data from the initial data sets are used or placed into an AI process or algorithm to facilitate impact profile and impact detection for new data. The training algorithm is configured to learn physical relationships in the input data to best describe these relationships or correlations. The data sets include information based on a number of factors including, for example, the acquired sensor readings, characterization of the impact detection, and response to the impact detection, or the like. The data is evaluated using a weighted evaluation where the weights are learned through a training process, through subject matter specifications, or the like. Deep learning mechanisms can augment an AI process to identify indicators in the sensor readings that can include, for example, the acquired sensor readings, characterization of the impact detection, and response to the impact detection, or the like.

In addition, Applicant asserts that processes, techniques, apparatus, and materials as known by one of ordinary skill in the relevant art may not be discussed in detail but are intended to be part of the enabling description where appropriate. For example, member formation and manufacturing may not be discussed in detail, however such processes as known by one of ordinary skill in the art and equivalent methods, processes, and materials would fall within the intended scope of exemplary embodiments. For example, materials, temperatures of formation, sizes of layers, and time increments for steps may be discussed, however other materials, times, temperatures, and sizes are meant to lie within the scope of exemplary embodiments.

In some instances, the machine learning IP 102 is able to suggest different results based on different levels of accuracy and personalized preferences to accommodate users desire for individuality. AI software may also suggests alternatives if no exact or directly related matches are available. AI software is agnostic and can apply to any phone number database from any country. AI software may further incorporate a pricing algorithm that categorizing numbers based on manual entry, number patterns, number relationships between last four, NPA and NPX, are codes, numbers of words it can spell, number of letters it uses, and provides highest value option. Relational databases are used to determine relevance, importance and commonality. Databases include for example sports related, business related, famous people, arts, music, affinity groups, social interests etc. AI software may also allows system to incorporate demand hierarchy component for additional price correction and/or sensitivity.

While the present innovation has been described with reference to exemplary embodiments, it is to be understood that the subject innovation is not limited to the disclosed exemplary embodiments. The scope of the subject innovation is to be accorded the broadest interpretation so as to encompass all modifications, equivalent structures and functions.

An example of the uses of the AI system is to create a storage and public access marketplace for numbers that allows individual and business users to search for, find, buy and, store numbers in a public forum that provides price transparency and easy access to any and all numbers available. This system creates a platform and a market for individual holders of phone numbers to economically store numbers that have value, rent, or sell numbers that have value. Currently its almost impossible with someone with a number they wish to monetize to find a way to do so in an easy, transparent and transaction risk free way to do it. The system allows users to port their numbers into a database and as part of a carriers numbers. This does several things, it allows the seller or storer to have lower storage fees and in the event of a sale or rental secures that a buyer will have access to the number. This platform acts as a guarantor of the transaction. The AI search system is the lynchpin of the this innovation as it allows for a creative and very individualized search and for instant results of availability of not, unlikely current systems that rely on human intermediaries or databases that can only search via area code or zip code and for very limited databases.

The subject innovation method is commenced by an end user engaging with the product electronically by signing up for an account via the internet and work station 10. If an end user has numbers that they wish to put on the open market they upload a CSV file of the numbers, together with the corresponding carrier information and an LOA (letter of agency), to transfer the number into the carrier account. The user can price their numbers as they wish or they can use the subject proprietary pricing software and algorithm to determine the price to consult.

The subject platform will provide a one place marketplace for the fragmented MVNO (mobile virtual network operator) and wireless carrier market. Individual and corporate users can use our platform to search for, compare and choose a wireless provider that fits their needs whether they are getting a new number(s) from our platform of they have an existing number(s) that they wish to move to a new provider. Incentives and marketing space will be provided to carriers to promote their services. Additional revenue sources will be second number solutions, home data plans and home streaming plans as well as used and new device vendors.

1. A method of assigning a telephone number to an end user comprising the steps of:
creating a database of number combinations;
correlating the database of number combinations to words in a desired language;
receiving input from the end user of one or more letter combinations that are of interest;
comparing the database of numbers to the letter combinations that are of interest to identify any correlations;
assigning a value to any said correlations; and
displaying said correlations with the assigned value to the end user for selection.

2. The method of claim 1, wherein the value assigned to a correlation is provided by one or more algorithm.

3. The method of claim 1, wherein the database of number combinations may include one or more third-party databases.

4. The method of claim 1, wherein the one or more letter combinations include a preceding and/or following number from zero to nine prior to identifying any correlations.

5. The method of claim 1, further comprising comparing the database of numbers to the letter combinations that are of interest to identify any correlations, in a specific area code.

6. The method of claim 5, wherein the database comprises more than one area code, and more than one area code may be selected when identifying a correlation.

7. The method of claim 1, wherein if the identification of correlations is not successful, a letter in the one or more letter combinations is correlated by using at least one phonetic equivalent letter and if a phonetic equivalent correlation is found, displaying said phonetic equivalent correlation to the end user.

8. The method of claim 1, further comprising the steps of: translating the one or more letter combinations into a different language and correlating the database with the translated letter combination.
